(19) United States
(12) Patent Application Publication
(10) Pub. No.: US 2025/0016893 A1
(43) Pub. Date: Jan. 9, 2025

(54) HOB DEVICE, HOB, HOB SYSTEM, AND METHOD FOR POSITIONING A SUPPORT UNIT

(71) Applicant: BSH Hausgeräte GmbH, Munich (DE)

(72) Inventors: Victor Camañes Vera, Zaragoza (ES); Cristina Blan Sanmartin, Huesca (ES); Eduardo Imaz Martinez, Tudela (Navarra) (ES); Jose Manuel Palacios Gasos, Zaragoza (ES); Manuel Fernandez Martinez, Zaragoza (ES); Lucia Herrero Lorente, Zaragoza (ES); Diego Puyal Puente, Zaragoza (ES); Javier Serrano Trullen, Zaragoza (ES); Rosario Romeo Velilla, Zaragoza (ES); Daniel Anton Falcon, Zaragoza (ES)

(21) Appl. No.: 18/710,638

(22) PCT Filed: Dec. 2, 2022
(86) PCT No.: PCT/EP2022/084160

§ 371 Date: May 16, 2024

(30) Foreign Application Priority Data
Dec. 3, 2021 (EP) 21383107.6

(51) Int. Cl. H05B 6/06

(52) U.S. Cl. CPC H05B 6/062; H05B 2213/05

(57) ABSTRACT

A cooktop apparatus includes a positioning unit designed to determine a target placement position for a placeable unit on a placement plate. The positioning unit determines the target placement position as a function of a characteristic parameter of the placeable unit. An output unit outputs the target placement position for a user.

### PRIOR ART

The invention relates to a cooktop apparatus as claimed in claim 1, a cooktop as claimed in claim 12, a cooktop system as claimed in claim 13 and a method for positioning a placeable unit as claimed in claim 14.

A “flex” cooktop apparatus having at least two cooking surface regions embodied separately from one another is already known from the prior art. A heating unit comprising in each case at least two heating elements is arranged in each of the at least two cooking surface regions. Furthermore, it has already been proposed that the heating elements of the first heating unit of the one cooking surface region differ from the heating elements of the second heating unit of the second cooking surface region with regard to a number and/or shape and/or size. A “free” cooktop apparatus with a heating unit is also known, wherein the heating unit embodies a single cooking surface region. The heating unit has a large number of heating elements, all of which are embodied identically to one another, namely all having the same shape and size and being arranged in a matrix.

The object of the invention lies in particular in providing a generic apparatus with improved properties with regard to convenience. This object is achieved according to the invention by the features of claims 1, 12, 13 and 14, while advantageous embodiments and developments of the invention can be taken from the subclaims.

### Advantages of the Invention

The invention relates to a cooktop apparatus, in particular an induction cooktop apparatus, with a positioning unit for determining a target placement position for a placeable unit, in particular an item of cookware, on a placement plate, in particular a cooktop plate, wherein the positioning unit determines the target placement position as a function of at least one characteristic parameter of the placeable unit, and with at least one output unit which is provided to output the target placement position for a user.

Such an embodiment makes it possible to increase convenience, namely user convenience for a user. In addition, advantageous support can be provided to the user when positioning at least one placeable unit on a placement plate. It is furthermore possible to increase flexibility, advantageously flexibility of use, namely with regard to a placement and/or heating of at least the placeable unit, wherein by means of a positioning unit a target placement position which is adapted to the placeable unit can be determined at all times as a function of at least one characteristic parameter of the placeable unit. It is moreover possible to increase efficiency, namely for example with regard to product and/or work and/or manufacturing and/or cost and/or performance efficiency. It is possible to achieve an effective and efficient heating of placed placeable units and/or an advantageous heat distribution, namely on account of an optimal positioning of at least the placeable unit on the placement plate. In addition, the user can be informed of the target placement position for the placeable unit in a convenient, advantageously uncomplicated and comprehensible manner by means of an output unit, so that a preferably improved cooking experience can be provided for the user. Furthermore, a guidance for positioning the placeable unit on the target placement position can be improved, advantageously made easier for the user. In addition, an advantageously intelligent and/or user-friendly cooktop apparatus, in particular cooktop, can be provided.

The cooktop apparatus could be embodied as a resistance cooktop apparatus and/or preferably as an induction cooktop apparatus. A “cooktop apparatus” is to be understood to mean at least a part, in particular a subassembly, of a cooktop, advantageously an induction cooktop, wherein in particular accessory units for the cooktop can additionally be included, such as for example a sensor unit for measuring a temperature of an item of cookware and/or food to be cooked. It would also be conceivable for the cooktop apparatus to comprise the entire cooktop. The cooktop apparatus and/or the cooktop is/are provided for use and/or arrangement in a household, in particular a kitchen. Advantageously, the cooktop is a matrix cooktop. The cooktop can in turn be part of a cooktop system, wherein the cooktop system could have a large number of units and/or apparatuses which can be used for food processing purposes. For example, the cooktop system could also have at least one extraction unit and/or at least the sensor unit and/or further sensor units, in particular at least one temperature sensor, which could be provided for positioning in the cookware and/or in the food to be cooked, for example in the form of a roasting spit.

The placement plate is at least one, in particular plate-like, unit which is provided for placing at least one placeable unit, namely at least the placeable unit already mentioned, and/or for placing at least one item of food, in particular the food to be cooked. The placement plate could be embodied for example as a worktop, in particular as a kitchen worktop, or as a subregion of at least one worktop, in particular at least one kitchen worktop, in particular of the cooktop system. Alternatively or in addition, the placement plate could be embodied as a cooktop plate. The placement plate embodied as a cooktop plate could embody in particular at least a part of a cooktop external housing and advantageously, together with at least one external housing unit to which the placement plate embodied as a cooktop plate could in particular be connected in at least one assembled state, could embody the cooktop external housing at least to a large extent. Preferably, the placement plate is made of a non-metallic material. The placement plate could be formed at least partly or at least to a large extent from glass and/or from glass ceramic and/or from Neolith and/or from Dekton and/or from wood and/or from marble and/or from stone, in particular from natural stone, and/or from laminate and/or from plastic and/or from ceramic and/or a compound material. The expression “to a large extent” is to be understood to mean at least 55%, advantageously at least 65%, preferably at least 75%, particularly preferably at least 85% and particularly advantageously at most 95% of a volume and/or mass proportion. In the present document, positional references such as “below” or “above”, for example, relate to an assembled state of the placement plate, provided this is not explicitly described otherwise.

The cooktop apparatus, in particular the placement plate, has at least one cooking surface region. In particular, the placeable unit is provided for placement in the cooking surface region. The cooking surface region is preferably embodied as a variable cooking surface region. A “variable cooking surface region” is to be understood in particular to mean a cooking surface region which is provided to form at least one heating zone which is adapted to at least the placed placeable unit, in particular the small household appliance and/or the item of cookware. The heating zone can preferably be adapted to the placeable unit at least with regard to a size and/or shape. Advantageously, the variable cooking surface region differs from a cooking surface in which the heating zones are defined in a fixed manner, in particular by markings on the placement plate. The cooktop apparatus preferably has at least one heating unit, which could be embodied as a resistance heating unit and/or preferably as an induction heating unit. In particular, the heating unit is arranged below the placement plate. The heating unit is preferably embodied as a matrix heating unit and in particular is provided to provide the variable cooking surface region. In particular, the heating unit has at least one heating element and preferably a large number of heating elements. A “heating unit” is to be understood to mean a unit which is provided to transfer electrical energy at least to a large extent to the placeable unit, at least in one operating mode, preferably through at least the placement plate, in particular the cooktop plate, and/or to convert electrical energy into heat, in order in particular to heat at least the placed placeable unit, preferably through at least the placement plate. In particular, the heating unit is provided to transfer a power of at least 100 W, in particular at least 500 W, advantageously at least 1000 W, preferably at least 2000 W, in at least an operating mode in which the heating unit is connected to a supply electronics unit of the cooktop apparatus or of the cooktop.

If the heating unit is embodied as an induction heating unit, the induction heating unit can have at least one heating element embodied as an inductor. Here an “inductor” is to be understood to mean an element which has at least one induction coil and/or is embodied as an induction coil, and which, in at least one operating mode, is provided to supply energy, in particular in the form of a magnetic alternating field, to at least one receiving element. The receiving element is embodied in particular as a part and/or a subassembly of a receiving unit and is provided in particular to receive the energy supplied by at least one inductor. The receiving unit can be part of the cooktop apparatus. Alternatively, it is conceivable for the receiving unit to be embodied as a unit which is independent of the cooktop apparatus and/or as part of a further apparatus which is independent of the cooktop apparatus. The receiving unit can be provided for placement on a region above the inductor and/or the further inductor. In particular, the receiving unit is part of the placeable unit. The placeable unit could be part of the small household appliance and/or of the item of cookware and/or of the underlay unit. The placeable unit could have at least one secondary coil as a receiving element for receiving the energy supplied by the inductor and/or further inductor. Alternatively or in addition, the receiving element could also be embodied as a metallic heating means, in particular as an at least partially ferromagnetic heating means, for example as a ferromagnetic base of the placeable unit, in particular of the item of cookware and/or of the underlay unit and/or of the small household appliance, in which, in the operating mode of the heating unit, eddy currents and/or remagnetization effects are produced by the inductor and are converted into heat.

The placeable unit can have a small household appliance and/or the item of cookware. The small household appliance could be for example a coffee machine and/or a toaster and/or a kettle and/or a mixer and/or a stirrer. Advantageously, the small household appliance could be supplied with energy at least partially inductively when placed onto the placement plate. The item of cookware can be embodied for example as a pot and/or pan and/or roaster. If the cooktop apparatus is embodied as an induction cooktop apparatus, the item of cookware could be supplied with energy at least for heating purposes at least partially inductively when placed onto the placement plate. It would also be conceivable for the placeable unit to comprise an underlay unit, which is provided to be laid under the item of cookware and/or the small household appliance. Advantageously, the underlay unit can be arranged between the placement plate and the item of cookware and/or the small household appliance. In particular, the underlay unit can be arranged in the cooking surface region. Advantageously, the heating unit is provided to heat the placeable unit in the cooking surface region.

The placeable unit has at least one characteristic parameter. The characteristic parameter is to be understood here to mean a parameter which at least partially characterizes the placeable unit. In particular, the characteristic parameter is correlated with the placeable unit. For example, the characteristic parameter describes an object shape and/or an object size and/or an object structure and/or a material composition of the placeable unit and/or a type of placeable unit, for example whether the placeable unit is the small household appliance and/or the item of cookware and/or the underlay unit. The placeable unit can be characterizable by means of at least the characteristic parameter. The characteristic parameter could comprise yet further variables which appear expedient to the person skilled in the art and help to characterize the placeable unit.

A “positioning unit” is to be understood to mean a unit which, in at least one operating mode, identifies a position of the placeable unit relative to the heating unit and provides the same in particular for further processing. The positioning unit is preferably provided for the user at least partially to support the positioning of the placeable unit on the placement plate. That “the positioning unit is preferably provided for the user at least partially to support the positioning of the placeable unit” is to be understood here to mean that the positioning unit supports the user at least partially in finding a suitable placement position, namely the target placement position for at least the placeable unit on the placement plate.

The positioning unit determines the target placement position for the placeable unit on the placement plate as a function of at least the characteristic parameter. Particularly preferably, the positioning unit determines the target placement position for the placeable unit on the placement plate as a function of at least a size and/or shape of the placeable unit.

The placeable unit could have for example a round, angular or oval shape. The placeable unit could have a small item of cookware, for example a small pot for preparing sauces, and/or a small-sized small household appliance, for example a coffee machine, with a size, in particular a base diameter, of at least substantially at least 3 cm, advantageously at least 5 cm, preferably at least 10 cm and particularly preferably of at most 15 cm. In this context, “at least substantially” is to be understood to mean that a deviation from a predefined value amounts to less than 25%, preferentially less than 10% and particularly preferably less than 5% of the predefined value.

The placeable unit could possibly have a conventional, in particular medium-sized, item of cookware and or small household appliance with a size, in particular a base diameter, of at least substantially at least 16 cm, advantageously at least 18 cm, preferably at least 20 cm and particularly preferably at most 24 cm. It would also be conceivable for the placeable unit to have a large item of cookware, for example a pan for frying and/or broiling and/or a pot for at least one braising or paella process, and/or a large-sized small household appliance, for example a mixer and/or stirrer, with a size, in particular a base diameter, of at least substantially at least 24.5 cm, advantageously at least 26 cm, preferably at least 28 cm and particularly preferably at most 35 cm.

Advantageously, the target placement position is stored in a database as a function of at least the characteristic parameter of the placeable unit. A “target placement position” is to be understood to mean a placement position, advantageously predefined and particularly preferably stored in the database, which placement position is correlated with at least the characteristic parameter of the placeable unit and forms a placement position on the placement plate which is in particular adapted optimally to the placeable unit for at least heating and/or inductive energy supply purposes. The positioning unit can be provided to access the database when determining the target placement position. In particular, the positioning unit accesses the database in at least one operating mode when determining the target placement position. In a method for positioning a placeable unit, in particular a method for operating the cooktop apparatus, the target placement position is determined as a function of a characteristic parameter of the placeable unit. In at least one operating step, a database in which at least one target placement position for at least one placeable unit can be stored could be accessed when determining the target placement position.

The database is preferably part of the household appliance apparatus. A “database” is to be understood to mean a unit which comprises at least one storage unit and is provided for storing a plurality of predefined target placement positions, such as for example at least 10 predefined target placement positions, at least 20 predefined placement positions or at least 100 predefined placement positions, in particular target placement positions of different types, in particular in a conflict-free manner and advantageously permanently. A “predefined object” is to be understood in this context to mean an object which is created, determined and/or specified in a manufacturing process, a setup process, an initialization process and/or an update process, in particular of the database and/or of the cooktop apparatus. Here, the predefined target placement positions are advantageously already created, determined and/or specified and in particular stored in the database during the manufacturing process, the setup process and/or the initialization process, in particular of the database and/or of the cooktop apparatus. Furthermore, the expression “target placement positions of different types” is to be understood to mean different target placement positions for at least one placeable unit on the placement plate. The “target placement positions of different types” could comprise only different placement positions on the placement plate for one and the same placeable unit. Alternatively and/or in addition, the “target placement positions of different types” could be in each case target placement positions for different types of placeable units, such as for example small items of cookware and/or small-sized small household appliances and/or conventional, in particular medium-sized, items of cookware and/or small household appliances and/or large items of cookware and/or large-sized small household appliances. A target placement position of a first type could be for example a target placement position for a small item of cookware on the placement plate. A target placement position of at least one second type could be for example a target placement position for a large item of cookware.

It would also be conceivable for the database to be an external database and part of the cooktop system. The cooktop apparatus could have at least one network unit. A “network unit” is to be understood in this context to mean a unit, in particular a network device, which is provided to provide an in particular wired and/or advantageously wireless network connection and/or network capability, in particular to generate a local network, such as for example a LAN network and/or a WLAN network, and/or a non-local network, such as for example a WAN network. The positioning unit could access the database, in particular the external database, for example by means of the network unit, when determining the target placement position.

In the method for positioning the placeable unit, the target placement position is output for a user by means of an output unit. The output unit can be a haptic, acoustic and/or preferably optical output unit. The output unit advantageously comprises at least one output element embodied as a display. Alternatively and/or in addition, the output unit can have an output element embodied as a communication element, which can be provided for example to send the target placement position to an advantageously mobile, electronic external device, such as for example a laptop, a tablet, a smartphone, a smartwatch and/or an equivalent electronic device. It would also be conceivable for the output unit to output the target placement position to the user for example by means of light signals and/or acoustic signals and/or by means of a vibration.

“Provided” is to be understood in this document to mean especially programmed, configured and/or equipped. That an object is provided for a particular function is to be understood to mean that the object fulfills and/or carries out this particular function in at least one usage and/or operating mode. Furthermore, numerals such as for example “first” and “second” which precede specific terms are only used for differentiation between method steps and/or objects and/or assignment between objects with one another and do not imply an existing overall number and/or ranking of the objects and/or of the method steps. In particular, a “second” object and/or method step does not necessarily imply a presence of a “first” object and/or method step.

It is further proposed that the positioning unit determines the target placement position in addition as a function of a cooktop function and/or a cooking process. As a result, convenience can be increased further and a positioning of at least one placeable unit can be optimized. As a result of an additional consideration of a cooktop function and/or a cooking process, an improved determination of a target placement position for the placeable unit can be provided, and the target placement position can preferably be determined more exactly and precisely. This in turn makes it possible to increase user convenience.

The cooktop function can be for example an operating function of the cooktop which is correlated with at least the placeable unit, in particular the type of the placeable unit. The cooktop could have at least two different cooktop functions for at least two different types of placeable units. A first cooktop function can be a first operating function of the cooktop for interaction with and/or for the operation of at least one placeable unit, which is for example the small item of cookware, in particular the pot for preparing sauces. The first cooktop function can differ from at least one second cooktop function. The second cooktop function could be a second operating function of the cooktop for interaction with and/or for the operation of at least one placeable unit, which is for example the large item of cookware, in particular the roaster. It would also be conceivable for the cooktop to have at least one third cooktop function, which is an operating function of the cooktop for interaction with and/or the operation of the placeable unit embodied as a small household appliance. In particular, the cooktop function is dependent on the type of the placeable unit. At least the cooktop function could be stored in the database.

Advantageously, the cooking process is a preferably predefined process of the cooktop, which could in particular be stored in the database, and to which at least one predefined heating power and/or a heating power density is assigned. The cooking process could be for example a frying process and/or a steam-cooking process and/or a braising process and/or a low-temperature cooking process and/or a grilling process and/or a deep-frying process and/or a roasting process and/or a boiling process. In particular in the method for positioning the placeable unit, in the operating step the target placement position is determined in addition to at least the characteristic parameter of the placeable unit as a function of a cooktop function and/or a cooking process.

It is further proposed that the cooktop apparatus has at least one cooktop operating unit, by means of which at least the characteristic parameter of the placeable unit and/or at least the cooktop function and/or at least the cooking process can be set by a user. Convenience, namely user convenience, can be further increased thereby. Furthermore, by means of the cooktop operating unit, a simple and convenient possibility can be offered to a user for setting at least one characteristic parameter of a placeable unit and/or at least one cooktop function and/or at least one cooking process for determining a target placement position for the placeable unit. This in turn makes it possible to increase efficiency, namely for example with regard to product and/or work and/or manufacturing and/or cost and/or performance efficiency. It is thus possible to provide a convenient and/or fast and/or efficient operation for the user and furthermore a convenient and/or fast and/or efficient determination of the target placement position.

The cooktop operating unit can be provided for the input and/or output of at least one item of information by and/or to the user. The item of information is preferably at least the characteristic parameter of the placeable unit and/or at least the cooktop function and/or at least the cooking process and/or at least one operating parameter for operating the cooktop. The operating parameter can be for example a heating power and/or a heating power density and/or a heating zone. The cooktop operating unit is provided in particular for an optical and/or acoustic and/or haptic communication between the user and at least one control unit of the cooktop apparatus. A “control unit” is to be understood to mean an electronic unit which is preferably at least partially integrated into a control and/or regulating unit of the cooktop and which is preferably provided to control and/or regulate at least the positioning unit and/or the output unit.

The user could select and/or input at least the characteristic parameter of the placeable unit and/or at least the cooktop function and/or at least the cooking process and/or at least the operating parameter by means of the cooktop operating unit. The cooktop operating unit could have at least one operating element for setting at least the characteristic parameter of the placeable unit and/or at least the cooktop function and/or at least the cooking process and/or at least the operating parameter. The cooktop operating unit is preferably embodied as a touch cooktop operating unit and has at least one touch sensor element. It would also be conceivable for the user to select and/or set the characteristic parameter of the placeable unit and/or at least the cooktop function and/or at least the cooking process and/or at least the operating parameter by means of a voice-controlled function of the cooktop operating unit. Alternatively and/or in addition, the cooktop operating unit can have a communication unit, which is preferably provided to communicate with the external device, for example a remote control, the laptop, the tablet, the smartphone, the smartwatch and/or an equivalent electronic device. It would also be conceivable for the user to select and/or set at least the characteristic parameter of the placeable unit and/or at least the cooktop function and/or at least the cooking process and/or at least the operating parameter by means of the external device. The communication unit could for example have at least one data line, in particular a cable, or particularly preferably be embodied as a wireless communication unit. The wireless communication unit could transmit a signal and/or data and/or at least the information, in particular between the cooktop operating unit and the external device, by means of microwaves and/or infrared radiation, for example by means of Bluetooth and/or Wi-Fi and/or NFC and/or RFIC and/or Zigbee and/or another suitable standard.

The output unit could be integrated at least partially into the cooktop operating unit. The output unit is preferably embodied at least partially and advantageously fully integrally, in particular in one piece, with the cooktop operating unit. In addition to the output of the target placement position, the output unit is preferably provided to output at least the characteristic parameter of the placeable unit and/or at least the cooktop function and/or at least the cooking process and/or at least one value of at least the operating parameter to the user.

“Integrally” is to be understood to mean at least connected with a material fit, for example by an adhesive bonding process, an injection-molding process and/or another process which appears expedient to a person skilled in the art. “In one piece” is to be understood to mean molded in one part. This one part is preferably manufactured from a single blank, a mass and/or a cast, particularly preferably in an injection-molding method, in particular a single- and/or multiple-component injection-molding method, and/or in a stamping method from the single blank.

It would be conceivable for the user to select and/or set a current placement position of the placeable unit by means of the cooktop operating unit. In order to increase convenience, namely user convenience, as well as efficiency, it is proposed that the cooktop apparatus has at least one sensor unit for capturing at least one current placement position of the placeable unit. This makes it possible to dispense with an additional user input with regard to an input of a current placement position of the placeable unit. The current placement position is preferably the actual position of the placeable unit on the placement plate. In particular, the sensor unit is provided to determine the current placement position of the placeable unit on the placement plate relative to the heating unit. Particularly preferably, the sensor unit is provided to acquire a location of the placeable unit. The location can be an alignment and/or orientation and/or position of the placeable unit relative to the placement plate, in particular the heating unit. The sensor preferably determines the current placement position of the placeable unit on the placement plate from at least the location of the placeable unit on the placement plate. The sensor unit can comprise for example an IR sensor and/or acceleration sensor and/or a weight sensor and/or a camera and/or an IR sensor. The sensor unit can acquire and/or determine the current placement position of the placeable unit with any process which is known and appears expedient to the person skilled in the art.

It would be conceivable for a guidance of the placeable unit from the current placement position to the target placement position to start automatically upon activation of the cooktop. The cooktop apparatus preferably has at least one guidance operating element, by means of which the guidance of the placeable unit from the current placement position to the target placement position by means of the positioning unit can be switched on and/or switched off. The guidance operating element can be part of the cooktop operating unit. By means of the guidance operating element, the user can activate and/or deactivate the guidance of the placeable unit to the target placement position. It would be conceivable for the cooktop apparatus to have several, namely at least two guidance operating elements, wherein each guidance operating element is assigned to a certain type of placeable unit. For example, the cooktop apparatus could have a first guidance operating element for activating and/or deactivating a guidance to the target placement position for a large item of cookware. Alternatively and/or in addition, the cooktop apparatus could have a second guidance operating element for activating and/or deactivating a guidance to the target placement position for a small household appliance, such as for example a coffee machine.

It is also proposed that the sensor unit is provided to acquire at least the characteristic parameter of the placeable unit. This makes it possible to further increase convenience. Furthermore, it is possible to dispense with an additional input of a user with regard to at least one characteristic parameter of a placeable unit and thus provide increased operating convenience. The sensor unit preferably acquires at least a size and/or a shape and/or a material composition of the placeable unit. The sensor unit can acquire and/or determine at least the characteristic parameter of the placeable unit with any process which is known and appears expedient to the person skilled in the art. In particular in the method for positioning the placeable unit, at least one characteristic parameter of the placeable unit is acquired by means of at least one sensor unit.

The output unit is preferably provided to output at least one at least two-dimensional output of the target placement position within the placement plate. This makes it possible to provide the user with an advantageously convenient, simple and comprehensible output of a target placement position of a placeable unit. It is furthermore possible to improve convenience, namely user convenience. In addition, a guidance for positioning the placeable unit on the target placement position can be improved, advantageously made easier for the user.

It would also be conceivable that the output unit can be provided to output an at least three-dimensional output of the target placement position within the placement plate. The output unit could have a laser unit, for example. By means of the laser unit, the output unit could display the target placement position three-dimensionally above the placement plate for the user, for example by means of a hologram. The placement plate preferably has the display of the output unit. Particularly preferably, the output of the target placement position takes place at least to a large extent and in particular exclusively within the placement plate. In the method for positioning the placeable unit, the target placement position is output to the user by means of the output unit within the placement plate.

In a further embodiment of the invention, it is proposed that the output unit is provided to output feedback regarding a conformity between a current placement position and the target placement position by means of a conformity parameter. This makes it possible to further improve convenience and support for a user when positioning at least one placeable unit on a placement plate. Furthermore, a guidance for positioning the placeable unit on a target placement position can be optimized, advantageously made easier for the user. In addition, clarity for the user with regard to a conformity between a current placement position and the target placement position can be improved. Furthermore, it is also possible to increase safety, in particular for the user.

The conformity parameter could be for example a type of progress indication regarding the conformity between the current placement position and the target placement position. The progress indication can comprise an indication of a current deviation and/or conformity when carrying out the positioning of the placeable unit. The conformity parameter can possibly comprise a progress bar and/or a status bar and/or a percentage display, in particular by means of a percentage value, and or a step display. In particular, the conformity parameter is provided to specify a degree of conformity between the current placement position and the target placement position. The conformity parameter advantageously specifies the extent of conformity between the current placement position and the target placement position. In the case of a percentage display, for example, it could be possible to display by means of the output unit that there is for example at least 10%, advantageously at least 50%, preferably at least 80% and particularly preferably 100% conformity between the current placement position and the target placement position. In particular, in the method for positioning the placeable unit, at least one item of feedback regarding a conformity between a current placement position and the target placement position is output to the user.

It would also be conceivable for the feedback regarding the conformity to take place on the basis of an acoustic signal. The conformity parameter could comprise at least one acoustic signal. It is possible that, in the event of conformity between the current placement position and the target position, at least the acoustic signal could be output to the user by means of the output unit. For example, it is possible that an even acoustic signal, for example a regular beeping, could be able to be output by means of the output unit as the placeable unit approaches the target placement position. In the event of conformity between the current placement position and the target placement position, the conformity parameter could comprise a continuous, even tone as an acoustic signal.

In order to further increase convenience and output an efficient and advantageously simple and uncomplicated feedback to the user with regard to a conformity between the current placement position and a target placement position, it is proposed that the conformity parameter changes with respect to visual appearance. This also makes it possible to further improve support for a user when positioning at least one placeable unit on a placement plate. Furthermore, a guidance for positioning the placeable unit on a target placement position can be optimized, advantageously made easier for the user. In addition, clarity for the user with regard to a conformity between a current placement position and the target placement position can be improved.

The visual appearance of the conformity parameter could change with respect to a shape and/or size and/or position and/or color. The conformity parameter could have for example a red color in the event of an absence of conformity between the target placement position and the current placement position. In the event of conformity between the target placement position and the current placement position, the visual appearance of the conformity parameter could change with respect to color, for example from red to green. It would also be conceivable for the conformity parameter to describe the conformity between the current placement position and the target placement position on the basis of a flashing and/or activation/deactivation of the visual appearance, for example.

In a further embodiment of the invention, it is proposed that the output unit is provided to output, in particular display, the target placement position on at least one cooking surface region of the placement plate. As a result, a comprehensible output of a target placement position can be provided directly on a cooking surface region for a user, thus increasing convenience. In addition, the user can be informed in a comprehensible and simple manner of the location of the target placement position in the cooking surface region. A guidance for positioning a placeable unit can be further optimized thereby.

The cooking surface region is preferably the aforementioned cooking surface region, in particular the variable cooking surface region. The output unit could be integrated at least partially into the placeable unit, namely in the part of the placeable unit having the cooking surface region. The output unit is preferably embodied at least partially and advantageously fully integrally, in particular in one piece, with the placeable unit. The output unit can be arranged on an underside of the placement plate. The output unit can have at least one display element, in particular a light source, for example at least one LED. The output unit could display the target placement position by means of at least the display element. In the case of the placement plate embodied as a glass ceramic plate, the output unit could display the target placement position to the user through the placement plate, in particular in an illuminated manner, by means of at least the display element. It would be conceivable for the output unit to display the target placement position using at least one individual light point, which preferably specifies the position of at least one heating element of the heating unit below the placement plate. Alternatively, it could be possible to display the target placement position to the user using an at least partially circumferential heating zone lighting. In the case of a placement plate embodied as a kitchen worktop, the output unit could output at least the target placement position through at least one opening in the placement plate. The display element could be visible through the opening in the placement plate and display the target placement position to the user. In particular, the individual light point is visible through the opening and preferably indicates the position at least of the heating element of the heating unit below the placement plate. Particularly preferably, the conformity parameter can be displayed by means of the display element.

If the output unit is provided to output, in particular display, the target placement position outside of at least one cooking surface region of the placement plate, a comprehensible display of a target placement position can be provided for a user, thus increasing convenience. This also makes it possible to further improve support for the user when positioning at least one placeable unit on a placement plate. Furthermore, a guidance for positioning the placeable unit on the target placement position can be optimized, advantageously made easier for the user. The output unit is preferably integrated into the cooktop operating unit. The output unit is preferably embodied at least partially, advantageously fully integrally, in particular in one piece, with the cooktop operating unit.

In particular, the output unit is provided to output, namely display, at least one representation of the cooking surface region. The output unit can display a representation of the target placement position to the user within the representation of the cooking surface region. For example, the output unit could display a representation of the placeable unit, for example an item of cookware, in the representation of the cooking surface region. It would be conceivable for the output unit to display a representation of the target placement position in the representation of the cooking surface region. The representation of the target placement position could take place by means of the representation of the placeable unit in the representation of the cooking surface region. The user could identify the target placement position for the placeable unit on the basis of the representation of the placeable unit in the representation of the cooking surface region. In addition, the output unit could display a representation of the target placement position of the placeable unit in the representation of the cooking surface region. The representation of the target placement position could take place by means of a further representation of the placeable unit in the representation of the cooking surface region.

It is further proposed that the output unit outputs at least one region which is occupied by the target placement position within the cooking surface region on the placement plate. This makes it possible to further improve a display of a target placement position for a placeable unit on a placement plate, thus increasing convenience, namely user convenience. In addition, a user can be provided with an overview of heating elements which are covered and/or occupied by a placeable unit in a target placement position. Here, an “occupied region” within the cooking surface region on the placement plate is to be understood to mean a region within the cooking surface region in which the placeable unit at least partially covers and/or occupies at least one heating element of the heating unit in the target placement position. The output unit can be provided to display a number of heating elements of the heating unit which are covered by the placeable unit in the target placement position.

The invention further relates to a method for positioning a placeable unit, in particular the aforementioned placeable unit, in particular for operating a cooktop apparatus, in particular the aforementioned cooktop apparatus, wherein a target placement position for the placeable unit on a placement plate is determined by means of a positioning unit as a function of at least one characteristic parameter of the placeable unit, and the target placement position is output for a user. The method for positioning the placeable unit, in particular for operating the cooktop apparatus, could have several method steps and/or method substeps. The method preferably comprises at least one method step. The method step could in turn consist of several method substeps.

Such a method makes it possible to increase convenience, namely user convenience. Furthermore, an optimal guidance for positioning the placeable unit on a target placement position can be provided for a user. This makes it possible to increase efficiency, namely for example with regard to product and/or work and/or manufacturing and/or cost and/or performance efficiency. Moreover, a particularly convenient and efficient method for positioning the placeable unit can be provided on the basis of the positioning unit.

Here, the cooktop apparatus and/or the cooktop and/or the method should not be restricted to the use and embodiment described above. In particular, the cooktop apparatus and/or the cooktop and/or the method can have a number of individual elements, parts, units and method steps deviating from a number mentioned herein for fulfilling a mode of operation described herein. Where value ranges are specified in this document, values lying within the specified limits are also to be deemed disclosed and usable in any desired manner.

### DRAWINGS

Further advantages will emerge from the following description of the drawings. The drawings show several exemplary embodiments of the invention. The drawings, the description and the claims contain numerous features in combination. The person skilled in the art will expediently also consider the features individually and combine them to form useful further combinations.

In the drawings:

FIG. 1 shows a schematic representation of a cooktop with a cooktop apparatus, which has a placement plate and a positioning unit for determining a target placement position for a placeable unit on the placement plate,

FIG. 2 shows a top view onto the placement plate with an output unit of the cooktop apparatus for displaying the target placement position,

FIG. 3 shows a schematic representation of a method for operating the cooktop apparatus,

FIG. 4 shows a cooktop apparatus in a further exemplary embodiment, and

FIG. 5 shows an output unit of a cooktop apparatus in a further exemplary embodiment.

### DESCRIPTION OF THE EXEMPLARY EMBODIMENTS

The figures described here are schematic representations and are not true to scale.

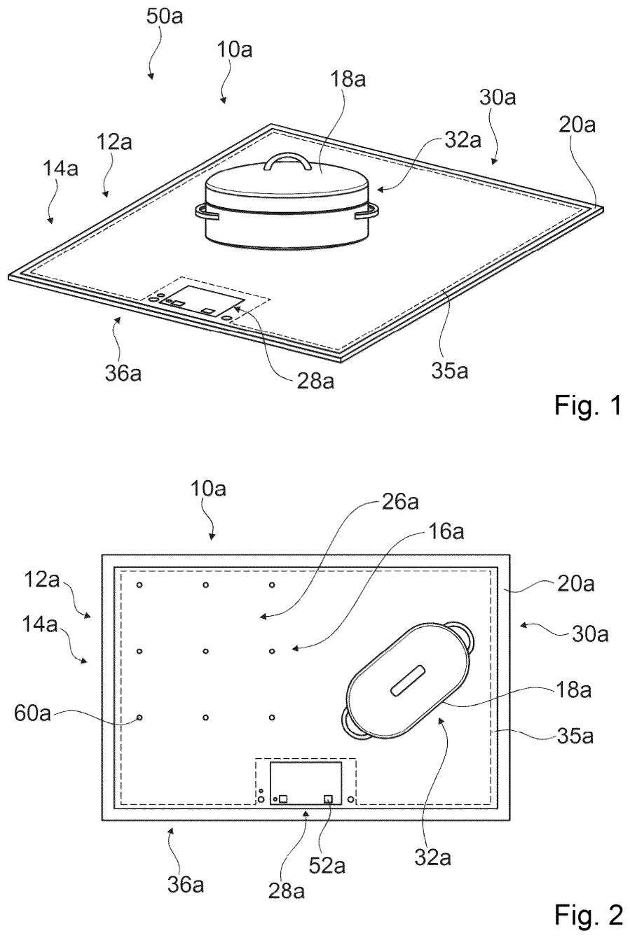

FIG. 1 shows a cooktop 10a with a cooktop apparatus 12a. Here, the cooktop apparatus 12a is embodied as an induction cooktop apparatus and the cooktop 10a as an induction cooktop. The cooktop apparatus 12a has a placement plate 20a for placing at least one placeable unit 18a. In this exemplary embodiment, the placement plate 20a is embodied as a cooktop plate. Alternatively and/or in addition, the placement plate 20a could be embodied at least in sections as a worktop, namely as a kitchen worktop. The placement plate 20a embodies a cooking surface for placing at least the placeable unit 18a. The cooktop apparatus 12a has a cooking surface region 35a. Here, the placement plate 20a has the cooking surface region 35a. In this exemplary embodiment, the placement plate 20a has exactly one, namely the cooking surface region 35a. Here, the cooking surface region 35a is embodied identically to the cooking surface.

The placeable unit 18a, as shown in FIGS. 1 and 2, is embodied by way of example as an item of cookware, namely as a pot. Alternatively and/or in addition, it would also be conceivable for the placeable unit 18a to be an underlay unit and/or a small household appliance, such as for example a kettle and/or a coffee machine and/or a mixer and/or a stirrer. In this exemplary embodiment, the item of cookware is a large item of cookware, namely an item of cookware with a size, namely a base diameter, of at least 25 cm.

The cooktop 10a and at least the placeable unit 18a are part of a cooktop system 50a. In addition, the cooktop 50a can have further units and/or apparatuses, which can be used for food processing purposes.

The cooktop apparatus 12a has a heating unit 36a with at least one heating element. The heating unit 36a is embodied as an induction heating unit. The heating unit 36a is arranged below the placement plate 20a. The heating unit 36a is provided to heat up at least one placeable unit 18a placed on the placement plate 20a above at least the heating element, namely at least the placeable unit 18a.

The cooking surface region 35a is a variable cooking surface region and here is free from markings and/or fixed positions for placing at least the placeable unit 18a. The variable cooking surface region 35a is provided to form at least one heating zone which is adapted to at least the placed placeable unit 18a.

For an optimal heating of at least the placeable unit 18a, the cooktop apparatus 12a has a positioning unit 14a. The positioning unit 14a is provided to determine a target placement position 16a for the placeable unit 18a on the placement plate 20a (cf. FIG. 2). The positioning unit 14a determines the target placement position 16a as a function of at least one characteristic parameter of the placeable unit 18a. Here, at least the characteristic parameter of the placeable unit 18a describes a size and/or a shape and/or a material composition and/or a type of the placeable unit 18a. The placeable unit 18a can be characterized by means of at least the characteristic parameter.

In this exemplary embodiment, the positioning unit 14a determines the target placement position 16a in addition as a function of a cooktop function and/or a cooking process. Here, the cooktop function is an operating function of the cooktop 10a which is correlated with at least the placeable unit 18a, in particular the type of the placeable unit 18a. The different types of placeable units 18a are to be understood to mean for example variously embodied placeable units 18a, such as the item of cookware and/or the small household appliance and/or the underlay unit.

The cooktop apparatus 12a has at least one sensor unit 30a for acquiring at least one current placement position 32a of the placeable unit 18a. In FIGS. 1 and 2, the placeable unit 18a is shown in a current placement position 32a in each case. The current placement position 32a is the actual position of the placeable unit 18a on the placement plate 20a. Here, the sensor unit 30a is provided to acquire at least the characteristic parameter of the placeable unit 18a. The sensor unit 30a can acquire at least a size and/or shape of the placeable unit 18a.

The cooktop apparatus 12a has at least one guidance operating element 52a for switching on and/or switching off a guidance of the placeable unit 18a from the current placement position 32a to the target placement position 16a by means of the positioning unit 14a. By means of the guidance operating element 52a, a user can activate and/or deactivate the guidance of the placeable unit 18a to the target placement position 16a.

The cooktop apparatus 12a has at least one cooktop operating unit 28a, by means of which at least the characteristic parameter of the placeable unit 18a and/or at least the cooktop function and/or at least the cooking process can be set by the user (cf. FIGS. 1 and 2).

The cooktop apparatus 12a has at least one output unit 26a for outputting the target placement position 16a for the user. The output unit 26a is provided to output at least one at least two-dimensional output of the target placement position 16a within the placement plate 20a (cf. FIG. 2). In this exemplary embodiment, the output unit 26a is provided to output the target placement position 16a on at least one cooking surface region 35a of the placement plate 20a. FIG. 2 shows the target placement position 16a by way of example using light points 60a on the cooking surface region 35a. In the interest of clarity, only one light point 60a is provided with a reference character.

The output unit 26a is provided to output feedback regarding a conformity between a current placement position 32a and the target placement position 16a by means of a conformity parameter. In this exemplary embodiment, the conformity parameter changes with respect to a visual appearance. In the event of an absence of conformity between the current placement position 32a and the target placement position 16a, the light points 60a shown in FIG. 2 could have a different color than in the event of conformity between the current placement position 32a and the target placement position 16a. The light points 60a have for example a red color in the event of an absence of conformity between the current placement position 32a and the target placement position 16a, and a green color in the event of conformity between the current placement position 32a and the target placement position 16a.

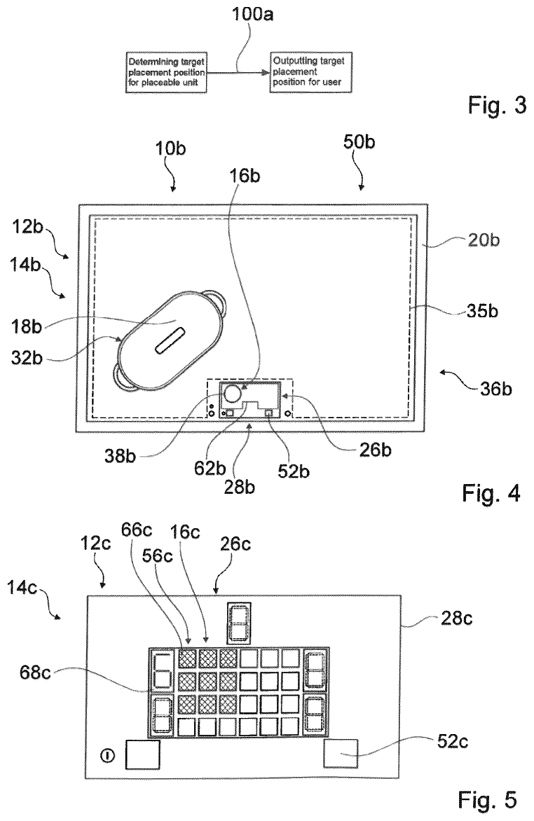

FIG. 3 shows a schematic representation of a method flowchart of a method for positioning a placeable unit 18a and further for operating the cooktop apparatus 12a. The positioning method could comprise several method steps. Here, the method is described by way of example only on the basis of one method step 100a. In the method for positioning the placeable unit 18a, the target placement position 16a for the placeable unit 18a is determined by means of the positioning unit 14a as a function of at least the characteristic parameter of the placeable unit 18a, and the target placement position 16a is output for the user.

FIGS. 4 and 5 show further exemplary embodiments of the invention. The following descriptions are essentially restricted to the differences between the exemplary embodiments, wherein with regard to components, features and functions which remain the same, reference can be made to the description of the exemplary embodiment in FIGS. 1 to 3. In order to differentiate the exemplary embodiments, the letter a in the reference characters of the exemplary embodiment in FIGS. 1 to 3 is replaced by the letters b and c in the reference characters of the exemplary embodiments in FIGS. 4 and 5. In principle, reference can also be made to the drawings and/or the description of the exemplary embodiment in FIGS. 1 to 3, in respect of components labeled the same, in particular in respect of components with identical reference characters.

FIG. 4 shows a cooktop 10b with a cooktop apparatus 12b of a further exemplary embodiment. The cooktop apparatus 12b has a placement plate 20b and an output unit 26b for outputting a target placement position 16b for a placeable unit 18b on the placement plate 20b. The cooktop apparatus 12b of the exemplary embodiment b differs from the cooktop apparatus 12a of the exemplary embodiment a by a position and/or arrangement of the output unit 26b for outputting the target placement position 16b. Here, the output unit 26b is provided to output the target placement position 16b outside of at least one cooking surface region 35b of the placement plate 20b.

The cooktop apparatus 12b has a cooktop operating unit 28b. The output unit 26b outputs at least the target placement position 16b in a region of the cooktop operating unit 28b. The cooktop apparatus 12b of the exemplary embodiment b differs from the cooktop apparatus 12a of the exemplary embodiment a in that the output unit 26b is embodied at least partially and here fully integrally, namely in one piece, with the cooktop operating unit 28b. In this exemplary embodiment, the output unit 26b outputs the target placement position 16b via the cooktop operating unit 28b.

The output unit 26b shows a representation 62b of the cooking surface region 35b. Here, the target placement position 16b is shown using a two-dimensional representation 38b of a placeable unit 18b. The representation 38b of the placeable unit 18b in the target placement position 16b is shown in the representation 62b of the cooking surface region 35b. This enables a user to identify the target placement position 16b for the placeable unit 18b within the cooking surface region 35b.

FIG. 5 shows an output unit 26c of a cooktop apparatus 12c in a further exemplary embodiment. Here, the output unit 26c is provided to output a target placement position 16c for a placeable unit 18c outside of at least one cooking surface region 35c of a placement plate 20c of the cooktop apparatus 12c. The cooktop apparatus 12c of the exemplary embodiment c differs from the cooktop apparatus 12b of the exemplary embodiment b in that the output unit 26c outputs at least one region 56c which is occupied by the target placement position 16c within the cooking surface region 35c on the placement plate 20c. The occupied region 56c specifies a region in which at least one heating element of a heating unit 36c arranged below the placement plate 20c is covered and/or occupied by the placeable unit 18c in the target placement position 16c. Here, FIG. 5 shows a representation 66c of at least one heating element of the heating unit 36c. In the interest of clarity, only one representation 66c of a heating element is provided with a reference character. This enables the user to identify how many heating elements of the heating unit 36c are covered by the placeable unit 18c in the target placement position 16c. It can further be seen from FIG. 5 that at least one operating parameter 68c can be output by means of the output unit 26c. Here, the operating parameter 68c is shown by way of example as a heat output.

### REFERENCE CHARACTERS

10 Cooktop
12 Cooktop apparatus
14 Positioning unit
16 Target placement position
18 Placeable unit
20 Placement plate
26 Output unit
28 Cooktop operating unit
30 Sensor unit
32 Current placement position
35 Cooking surface region
36 Heating unit
38 Representation
50 Cooktop system
52 Operating element
56 Occupied region
60 Light point
62 Representation
66 Representation
68 Operating parameter
100 Method step

1-14. (canceled)

15. A cooktop apparatus, comprising:
a positioning unit designed to determine a target placement position for a placeable unit on a placement plate, the positioning unit determining the target placement position as a function of a characteristic parameter of the placeable unit; and
an output unit designed to output the target placement position for a user.

16. The cooktop apparatus of claim 15, constructed in a form of an induction cooktop apparatus.

17. The cooktop apparatus of claim 15, wherein the positioning unit determines the target placement position in addition as a function of a cooktop function and/or a cooking process.

18. The cooktop apparatus of claim 17, further comprising a cooktop operating unit designed to enable the user to set the characteristic parameter of the placeable unit and/or the cooktop function and/or the cooking process.

19. The cooktop apparatus of claim 15, further comprising a sensor unit designed to acquire a current placement position of the placeable unit.

20. The cooktop apparatus of claim 19, wherein the sensor unit is designed to acquire the characteristic parameter of the placeable unit.

21. The cooktop apparatus of claim 15, wherein the output unit is designed to output a two-dimensional output of the target placement position within the placement plate.

22. The cooktop apparatus of claim 15, wherein the output unit is designed to output a feedback regarding a conformity between a current placement position and the target placement position by means of a conformity parameter.

23. The cooktop apparatus of claim 22, wherein the conformity parameter changes with respect to a visual appearance.

24. The cooktop apparatus of claim 15, wherein the output unit is designed to output the target placement position on a cooking surface region of the placement plate.

25. The cooktop apparatus of claim 15, wherein the output unit is designed to output the target placement position outside of a cooking surface region of the placement plate.

26. The cooktop apparatus of claim 25, wherein the output unit outputs a region which is occupied by the target placement position within the cooking surface region on the placement plate.

27. A cooktop, comprising the cooktop apparatus as set forth in claim 26.

28. A cooktop system, comprising:
a placeable unit on a placement plate; and
a cooktop comprising a positioning unit designed to determine a target placement position for the placeable unit as a function of a characteristic parameter of the placeable unit, and an output unit designed to output the target placement position for a user.

29. A method for positioning a placeable unit, in particular for operating a cooktop apparatus, the method comprising:
determining a target placement position for the placeable unit on a placement plate by a positioning unit as a function of a characteristic parameter of the placeable unit; and
outputting the target placement position for a user.

30. The method of claim 29, further comprising determining the target placement position in addition as a function of a cooktop function and/or a cooking process.

31. The method of claim 29, further comprising acquiring a current placement position of the placeable unit.

32. The method of claim 29, further comprising outputting a two-dimensional output of the target placement position within the placement plate.

33. The method of claim 29, further comprising outputting a feedback regarding a conformity between a current placement position and the target placement position by means of a conformity parameter.

34. The method of claim 29, further comprising outputting the target placement position on a cooking surface region of the placement plate.
